(19) United States
(12) Patent Application Publication
(10) Pub. No.: US 2026/0330445 A1
(43) Pub. Date: Oct. 22, 2026

(54) SYSTEMS AND METHODS FOR USE IN PROVISIONING TOKEN CREDENTIALS

(71) Applicant: MASTERCARD INTERNATIONAL INCORPORATED, PURCHASE, NY (US)

(72) Inventors: Akshat GUPTA, Glastonbury, CT (US); Anthony Steven COOPER, St. Peters, MO (US); Iain SHAND, Broxbourne (GB); Mark METCALFE, Hoboken, NJ (US); Matthias Wolfgang SIGMUND, Köln (DE); Niravkumar PANDYA, Morganville, NJ (US); Rahul CHANDRAN, Short Hills, NJ (US); Russell Anthony DE LACY, Wilton, CT (US); Sean Patrick DAILEY, O'Fallon, MO (US)

(21) Appl. No.: 19/651,439

(22) Filed: Apr. 17, 2026

Related U.S. Application Data
(60) Provisional application No. 63/791,284, filed on Apr. 18, 2025.

(51) Int. Cl. G06Q 20/36; G06F 3/04842; H04L 9/32

(52) U.S. Cl. CPC G06Q 20/36; H04L 9/3213; G06F 3/04842

(57) ABSTRACT

Systems and methods are provided for provisioning affiliate tokens to mobile devices. One example method includes receiving, from a mobile device of a user, a request to provision a token to the mobile device for use in participating in an affiliate program, and in turn submitting an eligibility check for an account of the user to a provider. The method also includes, in response to the provider confirming eligibility of the user's account, providing token art for the affiliate program to the mobile device and submitting account information for the account and the token art to the provider. The method further includes receiving, from the provider, token data for the token to be provisioned to the mobile device and requesting the token be provisioned to the mobile device, based on the token data, whereby the token is provisioned to a wallet application of the mobile device.

### CROSS-REFERENCE TO RELATED APPLICATION

This application claims the benefit of, and priority to, U.S. Provisional Patent Application No. 63/791,284, filed on Apr. 18, 2025. The entire disclosure of the above application is incorporated here by reference.

### FIELD

The present disclosure is generally directed to systems and methods for use in provisioning token credentials and, in particular, to systems and methods for use in provisioning token credentials, specific to affiliates, to digital applications.

### BACKGROUND

This section provides background information related to the present disclosure which is not necessarily prior art.

Payment accounts are known to be used to fund transactions for the purchase of products (e.g., goods, services, etc.) from first parties. In connection therewith, users are known to present cards to the first parties, as mechanisms of identifying the users'accounts. More recently, users have relied upon digital wallet applications, in mobile devices, for example, to pass account credentials to first parties in connection with transactions.

In order to provision the accounts to the digital wallet applications, users are required to provide the account credentials to the digital wallet applications and then perform authentications for the accounts, whereupon tokens specific to the issuing institutions of the accounts are added to the applications. In this way, the account are accessible through the tokens in the applications.

### BRIEF DESCRIPTION OF THE DRAWINGS

The drawings described herein are for illustrative purposes only of selected embodiments and not all possible implementations, and are not intended to limit the scope of the present disclosure.

FIG. 1 illustrates an example system of the present disclosure suitable for use in provisioning affiliate tokens;

FIG. 2 is a block diagram of an example computing device that may be used in the system of FIG. 1;

FIG. 3 illustrates an example method, which may be implemented in connection with the system of FIG. 1, for use in provisioning an affiliate token, specific to an affiliate, to a digital wallet associated with the user, whereby the affiliate token is available for presentation to identify an account and also for interacting with the affiliate; and

FIGS. 4A-4C illustrate multiple example interfaces, which may be used in connection with provisioning an affiliate token consistent with the method of FIG. 3.

Corresponding reference numerals indicate corresponding parts throughout the several views of the drawings.

### DETAILED DESCRIPTION

Example embodiments will now be described more fully with reference to the accompanying drawings. The description and specific examples included herein are intended for purposes of illustration only and are not intended to limit the scope of the present disclosure.

When accounts are issued by issuing institutions, the accounts may be provisioned as tokens to digital wallets, whereby the tokens are usable from the digital wallets to identify the accounts. The accounts may be associated with benefits or programs provided by the issuing institutions but are generally limited in what other benefits may be associated with the accounts. That is, for example, where an issuing institution (of an account) is associated with an affiliate for a special program, the program is integral to the account and exists for the duration of the account (and cannot be changed). In this way, the account is issued by the issuing institution, but limited in the program with the affiliate that is associated with the account. Consequently, a user may seek to have a new account issued, by the issuing institution, for each affiliate with which the user intends to engage.

Uniquely, the systems and methods herein provide for improved provisioning of affiliate tokens to accounts, where each affiliate token is specific to an affiliate, whereby the same account is enabled to be provisioned in connection with multiple different affiliates.

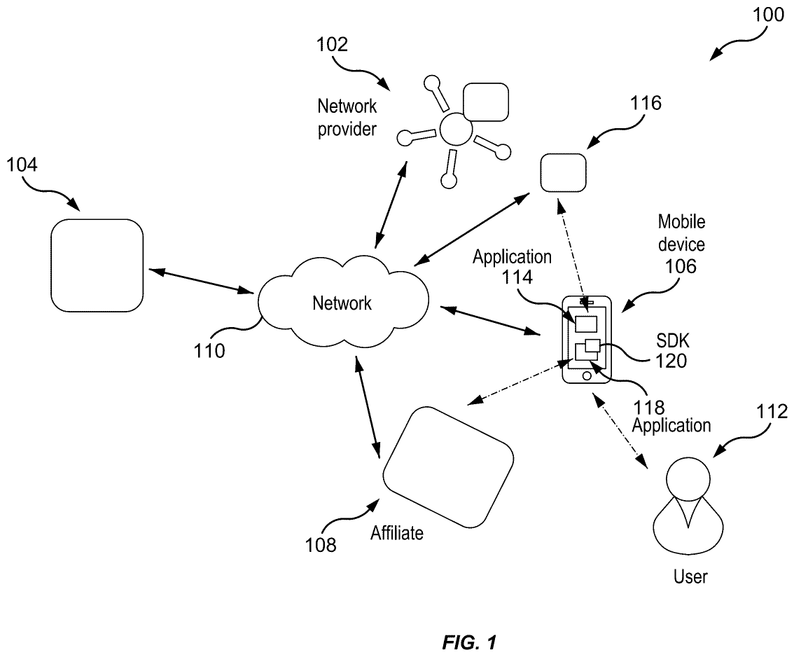

FIG. 1 illustrates an example system 100 in which one or more aspects of the present disclosure may be implemented. Although the system 100 is presented in one arrangement, other embodiments may include the parts of the system 100 (or other parts) arranged otherwise depending on, for example, relationships between users and affiliates and/or third parties in the system 100; types of digital wallets; particular affiliates; privacy rules, regulations, and requirements; etc.

The system 100 generally includes a network provider 102, an issuing institution 104, a mobile device 106, and an affiliate 108, each of which is coupled to a network 110. The network 110 may include one or more of, without limitation, a local area network (LAN), a wide area network (WAN) (e.g., the Internet, etc.), a mobile network, a virtual network, and/or another suitable public and/or private network capable of supporting communication among two or more of the parts illustrated in FIG. 1, or any combination thereof. For example, in at least one embodiment, the network 110 may include a private network through which the network provider 102 is coupled to the issuing institution 104, and a public network (e.g., the Internet, etc.) through which the mobile device 106 is coupled to the network provider 102, for example.

In the illustrated system 100, the network provider 102 includes (or is) a payment services provider or a payment processing network, which is configured to facilitate and/or coordinate account transactions (e.g., through messaging, etc.) between different entities (e.g., between consumers and first parties and involving institutions, etc.), whereby funds are transferred among accounts associated with users of the accounts pursuant to the transactions. The network provider 102 may be, for example, the MASTERCARD processing network, etc. In connection therewith, the network provider 102 is configured to coordinate authorization, clearing and settlement for account transactions by and through acquirer banking institutions (e.g., on behalf of first parties, etc.) and issuer banking institutions (e.g., the issuing institution 104, etc.) (e.g., on behalf of users, etc.). That said, in general, the network provider 102 is provided herein to coordinate authentication of users (e.g., a user 112 in FIG. 1, etc.) to/from parties associated with accounts provided to the users, including, for example, the issuing institution 104. In various embodiments, the network provider 102 may employ a digital enablement service, configured to operate as described herein, to support such user identity validation, etc. One example of such a digital enablement service includes the Mastercard Digital Enablement Service™ or MDES (provided by Mastercard®).

The issuing institution 104 in the system 100 may include (or may be referred to herein as) a financial institution, which includes a company, a business, or another entity through which entities and/or users may be able to transfer, hold and/or manage funds or other financials, etc. With that said, in the illustrated system 100, the issuing institution 104, in general, provides or issues accounts to entities or users, including the user 112, through which the users are permitted to hold funds, transfer funds to/from other accounts, etc. The accounts may include credit accounts, debit accounts, prepaid accounts, or other suitable types of accounts, etc.

The mobile device 106 in the system 100 is associated with the user 112. The mobile device 106 may include, for example, a smartphone, a smart watch, a wearable device, a tablet, or other mobile device (e.g., to be carried with the user 112, etc.), in any suitable form factor. As also shown in FIG. 1, the mobile device 106 includes a wallet network-based application 114, which is downloaded to and/or installed in the mobile device 106. In the illustrated embodiment, the application 114 is a digital wallet application (or virtual wallet application), in that it configures the mobile device 106 to store tokens specific to accounts and to (upon user input, tap, movement, etc.) present the tokens as account credentials to first parties (not shown) (e.g., merchants, etc.) in connection with account transactions. Examples of such application 114 may include, for example, Apple Pay® from Apple®, Google Pay® from Google®, SamsungPay® from Samsung®, etc., or other wallet-type applications.

It should be appreciated that the wallet application 114 is associated with a wallet provider 116. The wallet provider 116 is configured to interact with the network provider 102 to enable tokens to be provisioned to the wallet application 114 in the mobile device 106. Similarly, the network provider 102 is configured to interact with the wallet provider 116 (and other parties (e.g., issuer institutions, etc.), etc.) to provision one or more tokens to the wallet application 114 to enable the user 112 to initiate transactions from the mobile device 106, as explained herein.

The one or more tokens provisioned to the wallet application 114 are conventionally based solely on the account, as issued, and the token art (e.g., image, brand, symbol, etc.) representative of the token, which is consistent with the account, as issued. As such, where a token is for a silver credit account, which, in turn, is issued by Bank A, the token art for the token provisioned to the wallet application 114 also includes the brand, an indication of the silver credit account, Bank A, and often includes a processing network (e.g., Mastercard, VISA, etc., processing network, etc.). Where the account is co-branded by another party (e.g., a retailer, hotel, airline, professional sports team, etc.), the token art generally also includes the co-branding. It should be appreciated that the token art is presented in the wallet application 114 consistent with the brands, processing network, institution, co-brand, etc. of the account, as issued by the issuing institution 104, for example. In general, changes to the brands, processing network, institution, co-brand, etc., included in the token art are only available through one or more different accounts being issued.

However, in this example embodiment, the issuing institution 104 is configured to designate a range of account numbers, which are eligible for affiliate tokens, and to identify the range of account numbers to the network provider 102, as explained below. The affiliate tokens include, generally, the same brand and institution (e.g., issuing institution, etc.) as part of the token art, but additionally include an affiliate (e.g., the affiliate 108, etc.), which is included for a duration of a program, or as requested by a user.

Specifically, with further reference to FIG. 1, the affiliate 108 includes a business, company, or other type of entity, which is configured to offer products (e.g., goods, services, etc.) to users. It should be further appreciated that the affiliate 108 is not an issuing institution for payment accounts, i.e., not the issuing institution 104 or other issuing institution. The affiliate 108 may be a seller/retailer of one or more products, a product manager (e.g., entity engaged to sell the one or more products through seller/retailers, etc.), a manufacturer or supplier of one or more products, or potentially, a brand manager for one or more products. Regardless of the affiliate's relationship with the one or more products (or the manufacturer or supplier of the products), the affiliate 108 is configured to offer incentives through one or more channels to the users in order to increase access, visibility, and/or purchasing of the one or more products. The incentives may be associated with one or more particular programs, which provide for user interactions and/or the promotion of product(s), brand, loyalty, etc. In connection therewith, the affiliate 108 is configured to offer an affiliate network-based application 118 to users.

As shown in FIG. 1, the mobile device 106 includes the affiliate network-based application 118, which is downloaded to and/or installed in the mobile device 106 by the user 112. The affiliate application 118 configures the mobile device 106 to display various interfaces associated with the affiliate 108 and to communicate from/to the affiliate 108 to/from the user 112, whereby various offers, rewards, incentives, or broadly, programs etc. and/or various information may be presented to, selected by, etc., the user 112.

It should be appreciated that the affiliate application 118 configures the mobile device 106 to present a program from the affiliate 108, through which a program offered by the affiliate 108 is associated with an account issued by the issuing institution 104.

In particular, the affiliate application 118 includes a software development kit (SDK) 120. The SDK 120 is provided by and/or associated with the network provider 102 and configures the mobile device 106 and/or the application 118 to interact with the wallet application 114 and/or the network provider 102, for provisioning the tokens, and also, affiliate tokens, to the wallet application 114 of the mobile device 106. It should be appreciated that the SDK 120 may be omitted from the system 100, and specifically, the affiliate application 118, when the affiliate application 118 is provided from the network provider 102 and therefore integrate the operations ascribed to the SDK 120, etc. In such embodiments, that is, the affiliate application 118 itself, rather than the SDK 120, configures the mobile device 106 to interact with the wallet application 114 and/or the network provider 102, as explained herein, etc.

At the outset, the user 112 accesses the affiliate application 118 at the mobile device 106. In response, the mobile device 106, as configured by the affiliate application 118, displays an affiliate program for an account of the user 112. The user 112 selects the affiliate program at the mobile device 106, whereupon the mobile device 106, as configured by the affiliate application 118, solicits the funding primary account number (FPAN) and the expiration date of a physical card associated with the account issued by the issuing institution 104, i.e., broadly, the payment credential. The user 112 responds to the solicitation by entering the FPAN and expiration date.

The mobile device 106, as configured by the affiliate application 118, transmits the FPAN and the expiration date, along with an affiliate program identifier, to the network provider 102. The network provider 102 is configured to determine if the account is eligible for the affiliate program (and/or the affiliate 108) based on the affiliate program identifier and a range of accounts for the issuing institution 104. The range of accounts, specifically, is designated by the issuing institution 104 as eligible for affiliate tokens. It should be appreciated that the range of accounts may be general to affiliate programs or specific to one or more affiliate program, or may be eligible for all available affiliate programs through the network provider 102.

In response to the account being eligible, the network provider 102 is configured to retrieve token art(s) consistent with the affiliate program identifier and the FPAN and to return the token art(s) to the mobile device 106 along with an indication of eligibility for the affiliate program.

The mobile device 106, as configured by the affiliate application 118, presents the token art to the user 112 and solicits a selection of the token art, or a selection among multiple token arts, as appropriate. Upon selection of the token art, the mobile device 106, as configured by the affiliate application 118, requests the affiliate 108 to add an affiliate token to the wallet application 114 at the mobile device 106. The request includes the token art, as selected by the user 112. The affiliate 108, in turn, is configured to submit a request for tokenization to the network provider 102, where the request includes the FPAN, expiration date, and the token art. The network provider 102 is configured to provision token data (e.g., token art, FPAN, etc.) to the mobile device 106, via the wallet provider 116.

In response to the token data, the mobile device 106, as configured by the wallet application 114, submits the token data to the network provider 102 in order to generate and store the token in the wallet application 114 in the mobile device 106.

Specifically, the network provider 102 is configured to interact with the issuing institution 104 to verify the eligibility of the account to be tokenized (and potentially also the affiliate 108 and/or the affiliate program, etc.), authenticate the user 112 (e.g., at the mobile device 106, etc.), and/or generate the affiliate token. It should be appreciated that the network provider 102 is configured to generate the affiliate token as a unique token, relative to other tokens for the same account. Once the affiliate token is generated, the network provider 102 is configured to provision the affiliate token to the wallet application 114 in the mobile device 106, whereupon the token art is displayed in the token application 114 as an option to be selected to initiate a transaction.

It should be appreciated that the network provider 102 and/or the issuing institution 104 may be configured to report transactions, via the affiliate token, to the affiliate 108 so that any incentives associated with the affiliate token may be provided to the user (e.g., through the affiliate application 118, etc.).

When the affiliate program is ended or expired, the affiliate 108 is configured to submit a removal request for the affiliate token to the network provider 102. In response, the network provider 102 is configured to transmit an instruction to the wallet application 114 in the mobile device 106 to remove the affiliate token. The mobile device 106, as configured by the wallet application 114, removes the affiliate token in response to the instruction. Additionally, or alternatively, the mobile device 106 may be configured by the wallet application 114 to remove the affiliate token in response to an expiration of the affiliate token identified by the affiliate 108 or the network provider 102 in connection with provisioning of the affiliate token.

It should be appreciated that the affiliate 108 is representative of various affiliates that may be included in the system 100, each being configured consistent with the affiliate 108 and associated with an affiliate application consistent with the affiliate application 118. In connection therewith, it should be appreciated that the account of the user 112 issued by the issuing institution 104 may be provisioned into the wallet application 114 as various different affiliate tokens. In this way, at purchase, the user 112 is enabled to access the wallet application 114 and to select from among the affiliate tokens with which to initiate the transaction. Accordingly, through enabling the affiliate tokens, the single account is usable to participate in various affiliate programs, without having to issue a new account for each such program.

It should be appreciated that while the network provider 102 is illustrated as a single entity and/or computing device in FIG. 1, the network provider 102 may be segregated into multiple different entities and/or computing devices in other embodiments. However, even in such embodiments, the network provider 102, overall, is still generally configured to operate as described herein. In addition, while only one issuing institution 104, one mobile device 106, one affiliate 108, and one user 112 are illustrated in the system 100, it should be appreciated that additional ones of these entities and/or parts may be included in other system embodiments.

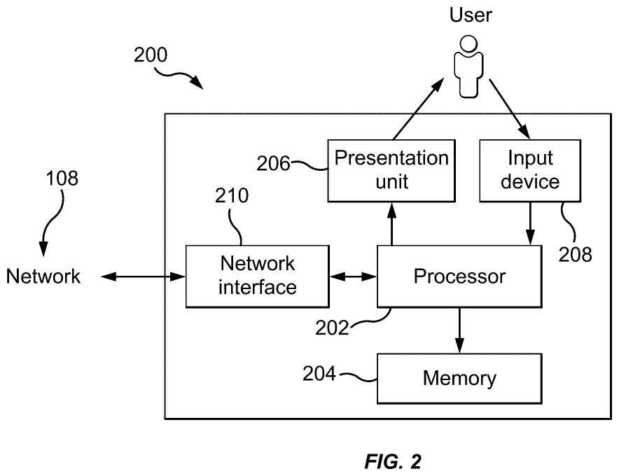

FIG. 2 illustrates an example computing device 200 that can be used in the system 100 of FIG. 1. The computing device 200 may include, for example, one or more servers, workstations, personal computers, laptops, tablets, smartphones, etc. In addition, the computing device 200 may include a single computing device, or it may include multiple computing devices located in close proximity or distributed over a geographic region, so long as the computing devices are specifically configured to function as described herein. In the example embodiment of FIG. 1, each of the network provider 102, the issuing institution 104, the mobile device 106, the affiliate 108, and the wallet provider 116 should be understood as including, or being implemented in, computing device 200, coupled to (and in communication with) one or more of the networks (e.g., the network 110, etc.). Notwithstanding the above, the system 100 should not be considered to be limited to the computing device 200, as described below, as different computing devices and/or arrangements of computing devices may be used in other embodiments. In addition, different components and/or arrangements of components may be used in other computing devices.

Referring to FIG. 2, the example computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), an EMV chip, a microcontroller, a reduced instruction set computer (RISC) processor, an application specific integrated circuit (ASIC), a programmable logic device (PLD), a gate array, and/or any other circuit or processor structured (e.g., by executable instructions, or programming, etc.) (e.g., as indicated by the application 118, the application 118 and/or the SDK 120, etc.) to perform the functions described herein.

The memory 204, as described herein, is one or more devices that permits data, instructions, etc., to be stored therein and retrieved therefrom. The memory 204 may include one or more computer-readable storage media, such as, without limitation, dynamic random-access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, token art, tokens, program identifiers, and/or other types of data (and/or data structures) suitable for use as described herein. Furthermore, in various embodiments, computer-executable instructions (e.g., in the form of the application 114, the application 118 and/or the SDK 120, etc.) may be stored in the memory 204 for execution by the processor 202 to cause the processor 202 to perform one or more of the functions described herein, such that the memory 204 is a physical, tangible, and non-transitory computer readable storage media. Such instructions often improve the efficiencies and/or performance of the processor 202 and/or other computer system components configured to perform one or more of the various operations herein. It should be appreciated that the memory 204 may include a variety of different memories, each implemented in one or more of the functions or processes described herein.

In the example embodiment, the computing device 200 also includes a presentation unit 206 that is coupled to (and is in communication with) the processor 202 (however, it should be appreciated that the computing device 200 could include output devices other than the presentation unit 206, etc.). The presentation unit 206 outputs information, visually or audibly, for example, to a user of the computing device 200 (e.g., display token art for an affiliate token, etc.), etc. And various interfaces (e.g., as defined by the application 114, the application 118 and/or the SDK 120, etc.) may be displayed at computing device 200, and in particular at presentation unit 206, to display certain information in connection therewith. The presentation unit 206 may include, without limitation, a liquid crystal display (LCD), a light-emitting diode (LED) display, an organic LED (OLED) display, an “electronic ink” display, speakers, etc. In some embodiments, the presentation unit 206 may include multiple devices.

In addition, the computing device 200 includes an input device 208 that receives inputs from the user (i.e., user inputs) of the computing device 200, such as, for example, selection, numeric inputs, etc., in response to prompts from applications herein, as further described below. The input device 208 may include a single input device or multiple input devices. The input device 208 is coupled to (and is in communication with) the processor 202 and may include, for example, one or more of a keyboard, a biometric sensor, a pointing device, a camera, a touch sensitive panel (e.g., a touch pad or a touch screen, etc.), another computing device, and/or an audio input device. In various example embodiments, a touch screen, such as that included in a tablet, a smartphone, or similar device, may behave as both the presentation unit 206 and an input device 208.

Further, the illustrated computing device 200 also includes a network interface 210 coupled to (and in communication with) the processor 202 and the memory 204. The network interface 210 may include, without limitation, a wired network adapter, a wireless network adapter (e.g., an NFC adapter, a Bluetooth™ adapter, etc.), a mobile network adapter, or other device capable of communicating to one or more different ones of the networks herein and/or with other devices described herein. Further, in some example embodiments, the computing device 200 may include the processor 202 and one or more network interfaces incorporated into or with the processor 202.

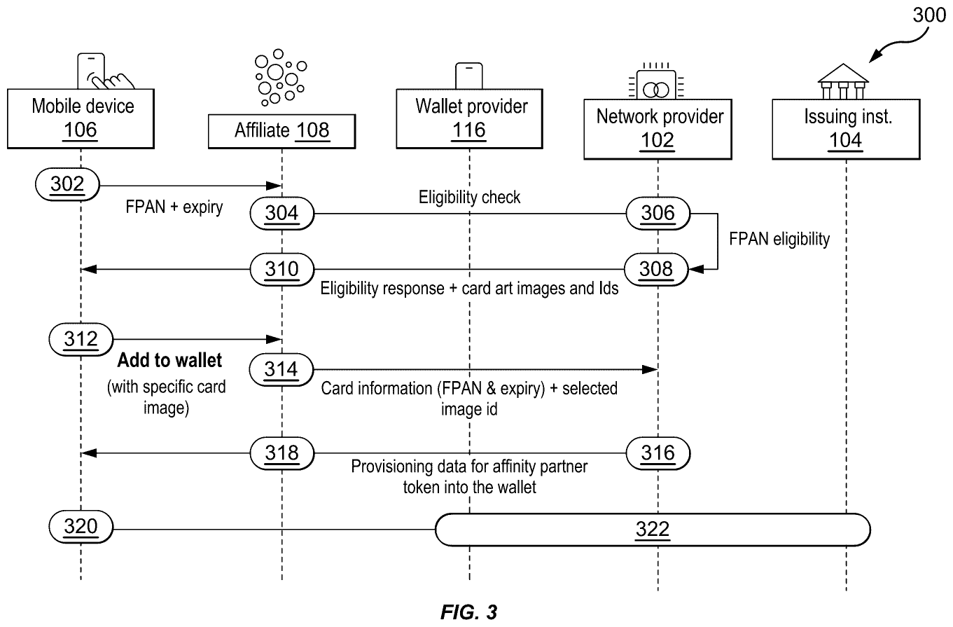

FIG. 3 illustrates an example method 300 for use in provisioning an affiliate token, specific to an affiliate, to a digital wallet associated with a user. The example method 300 is described as implemented in the network provider 102, the mobile device 106, and other parts of the system 100. Reference is also made to the computing device 200. However, the methods herein should not be understood to be limited to the system 100 or the computing device 200, as the methods may be implemented in other systems and/or computing devices. Likewise, the systems and the computing devices herein should not be understood to be limited to the example method 300.

At the outset in the method 300, it should be appreciated that the user 112 is in possession of the mobile device 106, in which the wallet application 114 and the affiliate application 118 are installed.

Also, the issuing institution 104 has issued an account to the user 112. The account (e.g., credit account, debit account, prepaid account, crypto account, etc.) may or may not be associated with “native” incentives (e.g., rewards, points, miles, etc.). The native incentives include the incentives included with the account by the issuing institution 104 or one or more sponsors associated with the account, at the issuance of the account and generally for the life the account. The native incentives exist for the account unless altered specifically by the issuing institution 104, etc. That is, once the user 112 applies for and is issued the account, the user 112 does not control, select, or otherwise opt in for the incentives, i.e., the incentives are native to the account.

Notably, the method 300 is performed, one or more times, after the account is already issued by the issuing institution 104 to the user 112.

In connection with the account issued by the issuing institution 104 to the user 112, as it relates to method 300, the user 112 decides to participate in an affiliate program being offered by the affiliate 108, whereby the user 112 has the option to assign or associate one or more transactions to the affiliate program. As such, the user 112 accesses the mobile device 106 and launches the affiliate application 118 at the mobile device 106. Upon doing so, the mobile device 106 displays one or more interfaces to the user 112, which includes various content associated with the affiliate 108. The user 112 may browse through interfaces and select an option to provision an affiliate token to the wallet application 114 and the mobile device 106.

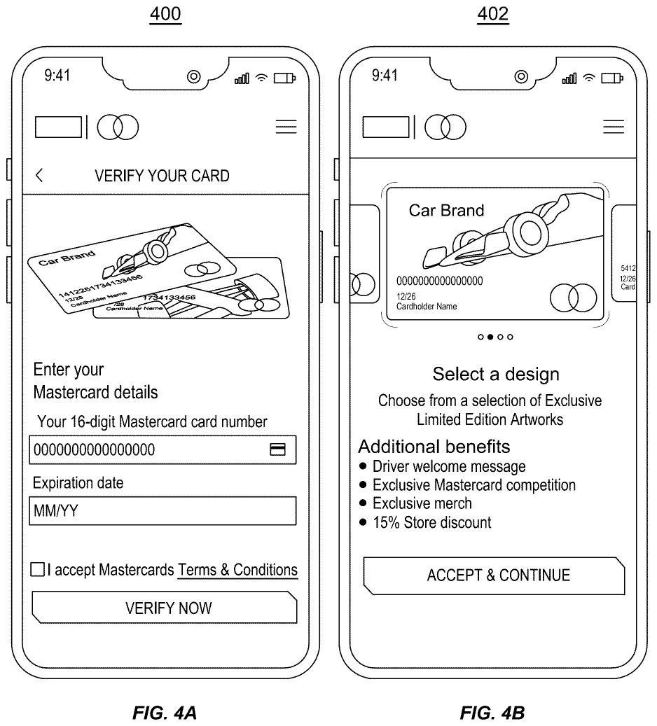

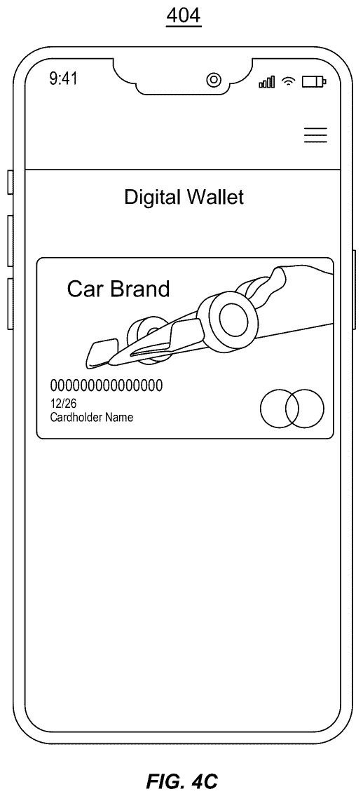

Upon selection of the option, the mobile device 106 solicits an account number for the account of the user 112. FIG. 4A illustrates an example interface 400 of the affiliate application 118, which includes a text box for entry of the FPAN associated with the account and also a text box for entry of the expiration date of the physical card associated with the account (e.g., credit card, debit card, prepaid card, etc.). In response to the solicitation, the user 112 enters the account number for the account. With reference to FIG. 4A, the user 112 enters the FPAN and the expiration date, for example, via an input device of the mobile device 106. It should be appreciated that more, less, or different information may be solicited to identify the account of the user 112. In at least one embodiment, the mobile device 106 instructs the user 112 to select a token from the wallet application 114, whereby the account is identified.

As shown in FIG. 3, at 302, the mobile device 106 transmits the FPAN and expiration date to the affiliate 108. In turn, at 304, the affiliate 108 transmits the FPAN and the expiration date to the network provider 102.

Upon receipt of the FPAN and the expiration date, the network provider 102 searches, at 306, for the account and a range of accounts from one or more issuing institutions, which designate accounts as eligible for affiliate tokens. In particular, the issuing institution 104 previously identified a range of accounts, which are eligible for affiliate tokens. The range of eligible accounts includes a segment of the primary account number, or the bank identification number (BIN), which is common to all accounts in the range.

If the FPAN is not located in a range of eligible accounts, the network provider 102 responds that the account is not eligible, whereupon the method 300 ends.

Conversely, if the FPAN is located in a range of eligible accounts, the network provider 102 provides, at 308, an eligibility response indicating eligibility of the account to the affiliate 108.

The affiliate 108 then retrieves the token art and affiliate program identifiers for one or more affiliate program(s) for which the account is eligible. The eligibility for each affiliate program may be based on time/date, the issuing institution 104, the user 112, location of the user 112 or issuing institution 104, etc. The affiliate 108 then provides, at 310, token art and the affiliate program identifiers for each of the affiliate program(s) to the mobile device 106.

In response, the mobile device 106 presents one or more affiliate program(s) to the user 112. In particular, in this example, FIG. 4B illustrates an interface 402 for the “car brand” affiliate 108, which includes the one or more affiliate programs. The interface 402 includes the token art for one of the affiliate programs and associated benefit/incentives (e.g., driver welcome message, store discount, etc.), and provides an ability for the user 112 to scroll to the other affiliate programs by swiping left or right. In response, the interface 402 displays the token art for the next one of the affiliate programs. In this manner, the user 112 is able to scroll through the affiliate programs, review the benefits of the affiliate programs, and review the token art for each of the affiliate programs. The user 112 ultimately selects one of the affiliate programs, and selects the “accept and continue” button in the interface 402. More generally, regardless of the particular interface, the user 112 selects one of the affiliate programs.

Based on the selection, the mobile device 106 transmits the token art and the affiliate program identifier for the selected affiliate program to the affiliate 108, at 312.

The affiliate 108 then transmits, at 314, the account information for the account of the user 112 and the token art to the network provider 102. In this example embodiment, the network provider 102 compiles token data, including the token art and the account information, and provisions the token data to the affiliate 108, at 316. The affiliate 108, in turn, provisions the token data to the mobile device 106, at 318.

In response, the mobile device 106 submits, at 320, to the network provider 102, a request to provision an affiliate token specific to the account, and having the token art, to the wallet application 114 in the mobile device 106. The network provider 102 cooperates, at 322, with the wallet provider 116 and the issuing institution 104 to: verify the request to provision the affiliate token, authenticate the user 112 in connection with the request (e.g., by a one-time passcode between the issuing institution 104 and the mobile device 106, etc.), confirm eligibility of the account to be tokenized by the issuing institution 104, generate the affiliate token and link the same to the account (e.g., defining mapping between affiliate token and FPAN, etc.) and then provision the affiliate token to the mobile device 106. FIG. 4C illustrates interface 404 in which the token art for the “car brand” affiliate 108 is illustrated, in connection with the corresponding affiliate token is provisioned to the mobile device 106.

It should be appreciated that the user 112 may select the affiliate token in the wallet application 114 and reenter the method 300 at step 310, effectively, whereupon the user 112 is permitted to select a different token art for the affiliate token (or the affiliate program). Upon selection of a different token art, the method 300 proceeds, as above, with a new token being generated, which includes the different token art, and provisioned to the wallet application 114.

It should be appreciated that the method 300 may be repeated one or more times for one or more additional affiliates, as selected by the user 112. As a result, when accessing the wallet application 114, at the mobile device 106, in connection with a transaction, the user 112 is permitted to select from multiple affiliate tokens, yet with each tied to the same account (e.g., the account issued by the issuing institution 104, etc.).

Regardless of which affiliate token is selected, the affiliate token is transferred from the mobile device 106 to the first party (e.g., merchant, etc.), whereupon the first party submits an authorization request for the transaction. The authorization request includes the affiliate token and details of the transaction, including, without limitation, amount of the transaction, transaction identifier, identifier associated with the first party, currency code, MCC, date/time, acquire identifier, address information, etc. After submission, the authorization request is received by the network provider 102 (e.g., through an acquiring institution, payment gateway, etc.). The network provider 102 identifies the affiliate token in the authorization request and detokenizes the affiliate token into the FPAN for the account. The network provider 102 appends the FPAN to the authorization request (e.g., in addition to or in place of the affiliate token, etc.), and further transmits the authorization request to the issuing institution 104. The issuing institution 104 is permitted to approve or decline the transaction based on one or more criteria established by the issuing institution 104 (e.g., credit limit, good standing of the account, rules associated with unauthorized transactions, etc.).

The issuing institution 104 then compiles and transmits, to the network provider 102, an authorization response to the authorization request. The authorization response includes an approval or decline of the transaction, and also the FPAN and other data for the transaction. The network provider 102, in turn, provides the authorization response back to the first party (e.g., through an acquiring institution, payment gateway, etc.).

In various embodiments, in connection with the above, the network provider 102 identifies the transaction to the affiliate 108 based on the affiliate token and notifies the affiliate 108. In turn, the affiliate 108 accounts for the user's participation in the affiliate program through use of the affiliate token (e.g., assign incentives thereto, etc.).

It should be appreciated that at the time of the end of the affiliate program, the affiliate 108 may direct the mobile device 106, the network provider 102, and/or the wallet provider 116 to delete or remove the affiliate token from the wallet application 114. In response thereto, either directly or indirectly, the mobile device 106 removes the affiliate token from the wallet application 114, whereby the affiliate token is no longer selectable, or viewable in the wallet application 114 by the user 112. In at least one embodiment, the affiliate token is a time-bound or time-limited token, which automatically expires at the end of the time. Upon expiration, mobile device 106 automatically deletes or removes the affiliate token from the wallet application 114.

Further, apart from expiration of the affiliate program, the user 112 may select to delete or remove the affiliate token from the wallet application 114 for any reason. In response, the mobile device 106 automatically deletes or removes the affiliate token from the wallet application 114.

When the affiliate token is removed or deleted from the wallet application 114 (for whatever reason), the mobile device 106, through the wallet application 114 and/or the affiliate application 118, may notify the affiliate 108 that the affiliate token is removed/deleted, whereby the user 112 is effectively out of the affiliate program.

In view of the above, the systems and methods herein provide for the provisioning of affiliate tokens to wallet applications, where each of the affiliate tokens is associated with the same account. In this way, the network provider is permitted to create relationships with affiliates whereby the affiliates can offer co-branding as a feature of an affiliate program. The co-branding permits the affiliate to participate in transactions for an account issued to the user, through the affiliate token at checkout. The affiliate tokens are readily changeable by the users, or the affiliate to enhance the affiliate program for the user.

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one or more of the following operations: (a) receiving, from a mobile device of a user, a request to provision an affiliate token to the mobile device for use in participating in one or more affiliate programs of an affiliate, the request including account data for an account issued to the user; (b) submitting, to a network provider, an eligibility check for the account; (c) in response to the network provider confirming eligibility of the account, providing token art for the one or more affiliate programs to the mobile device; (d) receiving the token art for a selected one of the one or more affiliate programs; (e) submitting account information for the account and the token art to the network provider; (f) receiving, by the affiliate computing device, from the network provider, token data for the affiliate token to be provisioned to the mobile device, the token data including the token art; (g) requesting the affiliate token be provisioned to the mobile device, based on the token data, whereby the affiliate token is provisioned to a wallet application of the mobile device; (h) in response to the token data, generating the affiliate token; (i) provisioning the affiliate token to the wallet application of the mobile device; (j) confirming eligibility of the account for the one or more affiliate programs based on a range of accounts identified by an issuing institution of the account; (k) notifying the affiliate of the eligibility of the account, based on an account number of the account being within the range of accounts; (l) receiving a second request to provision a second affiliate token to the mobile device for use in participating in one or more second affiliate programs of a second affiliate; and/or (m) after the affiliate token is provisioned to the mobile device, displaying the token art in the wallet application for selection by the user.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” and the term “at least one of” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

The foregoing description of example embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in provisioning an affiliate token to a mobile device, the method comprising:
receiving, by an affiliate computing device, from a mobile device of a user, a request to provision an affiliate token to the mobile device for use in participating in one or more affiliate programs of an affiliate, the request including account data for an account issued to the user;
submitting, by the affiliate computing device, to a network provider, an eligibility check for the account;
receiving, from the network provider, based on eligibility of the account for the one or more affiliate programs, token art for the one or more affiliate programs;
receiving, by the affiliate computing device, from the mobile device, a selection of one of the one or more affiliate programs;
submitting, by the affiliate computing device, account information for the account and an indication of the selected one of the one or more affiliate programs, to the network provider;
receiving, by the affiliate computing device, from the network provider, token data for an affiliate token to be provisioned to the mobile device, the token data including the account information for the account and the token art; and
requesting, by the affiliate computing device, the affiliate token be provisioned to the mobile device, based on the token data, whereby the affiliate token is provisioned to a wallet application of the mobile device, the affiliate token being consistent with the token art for the selected one of the one or more affiliate programs.

2. The computer-implemented method of claim 1, wherein the account data for the account includes a funding primary account number (FPAN) and an expiration date associated with the account; and
wherein the token art is indicative of a processing network of the account and/or an issuing institution of the account, based on the FPAN.

3. The computer-implemented method of claim 1, wherein the token art includes a logo or brand of the affiliate.

4. The computer-implemented method of claim 1, further comprising:
in response to the token data, generating, by the network provider, the affiliate token specific to the account and the selected one of the one or more affiliate programs; and
provisioning, by the network provider, the affiliate token to the wallet application of the mobile device.

5. The computer-implemented method of claim 4, further comprising:
confirming, by the network provider, eligibility of the account for the one or more affiliate programs based on a range of accounts identified by an issuing institution of the account; and
notifying, by the network provider, the affiliate of the eligibility of the account, based on an account number of the account being within the range of accounts.

6. The computer-implemented method of claim 1, further comprising:
receiving, by a second affiliate computing device, a second request to provision a second affiliate token to the mobile device for use in participating in one or more second affiliate programs of a second affiliate; and
submitting, by the second affiliate computing device, to the network provider, a second eligibility check for the account;
receiving, from the network provider, based on eligibility of the account for the one or more second affiliate programs, second token art for the one or more second affiliate programs;
receiving, by the second affiliate computing device, from the mobile device, a selection of one of the one or more second affiliate programs;
submitting, by the affiliate computing device, the account information for the account and the second token art for the selected one of the one or more affiliate programs, to the network provider;
receiving, by the second affiliate computing device, from the network provider, second token data for an affiliate token to be provisioned to the mobile device, the second token data including the account information for the account and the second token art; and
requesting, by the second affiliate computing device, the second affiliate token be provisioned to the mobile device, based on the second token data, whereby the second affiliate token is provisioned to the wallet application of the mobile device, the second affiliate token being consistent with the second token art for the selected one of the one or more second affiliate programs.

7. The computer-implemented method of claim 1, further comprising:
after the affiliate token is provisioned to the mobile device, displaying, by the mobile device, the token art in the wallet application for selection by the user in connection with a transaction to the account, whereby an incentive defined by the selected one of the one or more affiliate programs is accrued to the user for use of the affiliate token.

8. The computer-implemented method of claim 7, further comprising:
displaying, by the mobile device, the one or more affiliate programs; and
receiving, by the mobile device, an input from the user selecting one of the one or more affiliate programs; and
communicating, by the mobile device, the selection of the one of the one or more affiliate programs to the affiliate computing device.

9. A system for use in provisioning an affiliate token to a mobile device, the system comprising:
an affiliate computing device, which is configured, by first executable instructions, to:
receive, from a mobile device of a user, a request to provision an affiliate token to the mobile device for use in participating in one or more affiliate programs of an affiliate, the request including account data for an account issued to the user;
submit, to a network provider, an eligibility check for the account;
receive, from the network provider, based on eligibility of the account for the one or more affiliate programs, token art for the one or more affiliate programs;
receive, from the mobile device, a selection of one of the one or more affiliate programs;
submit account information for the account and an indication of the selected one of the one or more affiliate programs, to the network provider;
receive, from the network provider, token data for an affiliate token to be provisioned to the mobile device, the token data including the account information for the account and the token art; and
request the affiliate token be provisioned to the mobile device, based on the token data, whereby the affiliate token is provisioned to a wallet application of the mobile device, the affiliate token being consistent with the token art for the selected one of the one or more affiliate programs.

10. The system of claim 9, wherein the account data for the account includes a funding primary account number (FPAN) and an expiration date associated with the account; and
wherein the token art is indicative of a processing network of the account and/or an issuing institution of the account, based on the FPAN.

11. The system of claim 9, wherein the token art includes a logo or brand of the affiliate.

12. The system of claim 9, further comprising the network provider, which is configured, by second executable instructions, to:
in response to the token data, generate the affiliate token specific to the account and the selected one of the one or more affiliate programs; and
provision the affiliate token to the wallet application of the mobile device.

13. The system of claim 12, wherein the network provider is further configured, by the second executable instructions, to:
confirm eligibility of the account for the one or more affiliate programs based on a range of accounts identified by an issuing institution of the account; and
notify the affiliate of the eligibility of the account, based on an account number of the account being within the range of accounts.

14. A non-transitory computer-readable storage medium including executable instructions, which when executed by at least one processor, cause the at least one processor to:
receive, from a mobile device of a user, a request to provision an affiliate token to the mobile device for use in participating in one or more affiliate programs of an affiliate, the request including account data for an account issued to the user;
submit, to a network provider, an eligibility check for the account;
receive, from the network provider, based on eligibility of the account for the one or more affiliate programs, token art for the one or more affiliate programs;
receive, from the mobile device, a selection of one of the one or more affiliate programs;
submit account information for the account and an indication of the selected one of the one or more affiliate programs, to the network provider;
receive, from the network provider, token data for an affiliate token to be provisioned to the mobile device, the token data including the account information for the account and the token art; and
request the affiliate token be provisioned to the mobile device, based on the token data, whereby the affiliate token is provisioned to a wallet application of the mobile device, the affiliate token being consistent with the token art for the selected one of the one or more affiliate programs.

15. The non-transitory computer-readable storage medium of claim 14, wherein the account data for the account includes a funding primary account number (FPAN) and an expiration date associated with the account.

16. The non-transitory computer-readable storage medium of claim 15, wherein the token art includes a logo or brand of the affiliate; and
wherein the indication of the selected one of the one or more affiliate programs includes the token art for the selected one of the one or more affiliate programs.

17. The non-transitory computer-readable storage medium of claim 16, wherein the token art is indicative of a processing network of the account and/or an issuing institution of the account, based on the FPAN.
